(19) United States
(12) Patent Application Publication
(10) Pub. No.: US 2005/0091642 A1
(43) Pub. Date: Apr. 28, 2005

(54) Method and systems for learning model-based lifecycle diagnostics

(76) Inventor: William L. Miller, Ada, MI (US)

Correspondence Address: MERCHANT & GOULD PC, P.O. BOX 2903, MINNEAPOLIS, MN, 55402-0903, US

(21) Appl. No.: 10/696,426

(22) Filed: Oct. 28, 2003

(51) Int. Cl. G06F 9/44

(52) U.S. Cl. 717/124; 717/104

(57) ABSTRACT

A system for learning model-based lifecycle diagnostics includes an integrated development environment, a run-time environment, and a bi-directional link. The integrated development environment includes software tools linked within. The run-time environment includes agents that detect failures linked within. The bi-directional link links the integrated development environment and the run-time environment. In the system, failures detected in the run-time environment can be traced back to the integrated development environment to determine model errors. A method of diagnosing model errors, in a software environment including an integrated development environment and a run-time environment bi-directionally linked, includes detecting failures within the run-time environment; tracing the failures back to the integrated development environment; and identifying the model errors in the integrated development environment based on the tracing of the failures.

### TECHNICAL FIELD

The present invention relates to software and systems, and more particularly to multi-level, multi-regime development tools and run-time software agents for integrated development and run-time environments.

### BACKGROUND

In the current paradigm of product development, the quality of a product, its production, and its service is mainly designed, tested, and implemented during development. Errors in a product, its production, or its service are identified during development and corrected. Once a product is released, it is difficult to find remaining quality problems.

Currently, a methodology, known as six sigma, attempts to locate root causes and failures in the product, mainly in development and manufacturing. These root cause activities are people intensive, involving “black belts” and other quality experts in addition to other disciplines such as engineering. Software is developed with a focus on people with knowledge, tools, technology, and good processes (model-driven software engineering) to find problems during development. Because software is developed with this focus and finding root causes is people intensive, improvements are desirable.

### SUMMARY

In accordance with the present invention, the above and other problems are solved by the following:

In one aspect of the present invention, a system for learning model-based lifecycle diagnostics is disclosed. The system includes an integrated development environment, a run-time environment, and a bi-directional link. The integrated development environment includes software tools linked within. The run-time environment includes agents that detect failures linked within. The bi-directional link links the integrated development environment and the run-time environment. In the system, failures detected in the run-time environment can be traced back to the integrated development environment to determine model errors.

In another aspect of the present invention, a method of diagnosing model errors in a software environment is disclosed. The software environment includes an integrated development environment and a run-time environment bi-directionally linked. The method includes detecting failures within the run-time environment; tracing the failures back to the integrated development environment; and identifying the model errors in the integrated development environment based on the tracing of the failures.

In another aspect of the present invention, a computer program product readable by a computing system and encoding instructions for a computer process for diagnosing model errors in a software environment that includes an integrated development environment and a run-time environment bi-directionally linked. The computer process includes detecting failures within the run-time environment; tracing the failures back to the integrated development environment; and identifying the model errors in the integrated development environment based on the tracing of the failures.

In another aspect of the present invention, a system for learning model-based lifecycle diagnostics for vehicles is disclosed. The system includes an integrated development environment, a run-time development, and a bi-directional link. The integrated development environment includes a requirements management tool, a design tool, and a deployment tool linked together. The run-time environment includes applications, brokers, and agents that detect failures linked together. The bi-directional link links the integrated development environment and the run-time environment. In the system, failures detected in the run-time environment are traced back to the integrated development environment to determine model errors.

The invention may be implemented as a computer process; a computing system, which may be distributed; or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

A more complete appreciation of the present invention and its scope may be obtained from the accompanying drawings, which are briefly described below, from the following detailed descriptions of presently preferred embodiments of the invention and from the appended claims.

### BRIEF DESCRIPTION OF THE DRAWINGS

Referring now to the drawings in which like reference numbers represent corresponding parts throughout:

FIG. 1 is a schematic representation of methods and systems for learning model-based lifecycle diagnostics, according to an exemplary embodiment of the present disclosure;

FIG. 2 is a schematic representation of a computing system that may be used to implement aspects of the present disclosure;

FIG. 3 is a block diagram of a the development of a product; according to an exemplary embodiment of the present disclosure;

FIG. 4 is a schematic representation requirements associated with a wicked problem, according to an exemplary embodiment of the present disclosure;

FIG. 5 is a schematic representation of methods and systems for learning model-based lifecycle diagnostics, according to an exemplary embodiment of the present disclosure;

FIG. 6 is a schematic representation of methods and systems for learning model-based lifecycle diagnostics, according to an exemplary embodiment of the present disclosure;

FIG. 7 illustrates an example graphic user interface, according to an exemplary embodiment of the present disclosure;

FIG. 8 is a schematic illustrating a distributed system, according to an exemplary embodiment of the present disclosure;

FIG. 9 is a process diagram illustrating a vehicle product development, according to an exemplary embodiment of the present disclosure;

FIG. 10 is a process diagram illustrating the spiral lifecycle process, according to an exemplary embodiment of the present disclosure;

FIG. 11 is a process diagram illustrating the spiral lifecycle process, according to an exemplary embodiment of the present disclosure;

FIG. 12 is a process diagram illustrating the vehicle development phase, according to an exemplary embodiment of the present disclosure;

FIG. 13 is a process diagram illustrating how the lifecycle method progresses through requirements, according to an exemplary embodiment of the present disclosure;

FIG. 14 is a process diagram illustrating how the lifecycle method applies a spiral sub process, according to an exemplary embodiment of the present disclosure;

FIG. 15 is a process diagram illustrating how the lifecycle method is applied, according to an exemplary embodiment of the present disclosure;

FIG. 16 is a process diagram illustrating how the lifecycle method progresses, according to an exemplary embodiment of the present disclosure;

FIG. 17 is a process diagram illustrating how the lifecycle method applies a spiral sub process, according to an exemplary embodiment of the present disclosure;

FIG. 18 is a process diagram illustrating how the lifecycle method is applied in the spiral sub process, according to an exemplary embodiment of the present disclosure;

FIG. 19 is a system diagram, according to an exemplary embodiment of the present disclosure;

FIG. 20 illustrates how the lifecycle method links the levels together, according to an exemplary embodiment of the present disclosure; and

FIG. 21 is a flow chart illustrating the logical operation of a lifecycle method, according to an exemplary embodiment of the present disclosure.

### DETAILED DESCRIPTION

In the following description of preferred embodiments of the present invention, reference is made to the accompanying drawings that form a part hereof, and in which is shown by way of illustration specific embodiments in which the invention may be practiced. It is understood that other embodiments may be utilized and changes may be made without departing from the scope of the present invention.

The present disclosure describes methods and systems for learning model-based lifecycle software and systems. More particularly, the software and systems include an integrated development environment (IDE) and a run-time environment (RTE) linked together. The IDE contains a set of development tools linked within the IDE and linked to the RTE. The RTE includes a number of diagnostic agents linked within the RTE and linked to the IDE. Thereby, the development tools and the diagnostic agents communicate with each other.

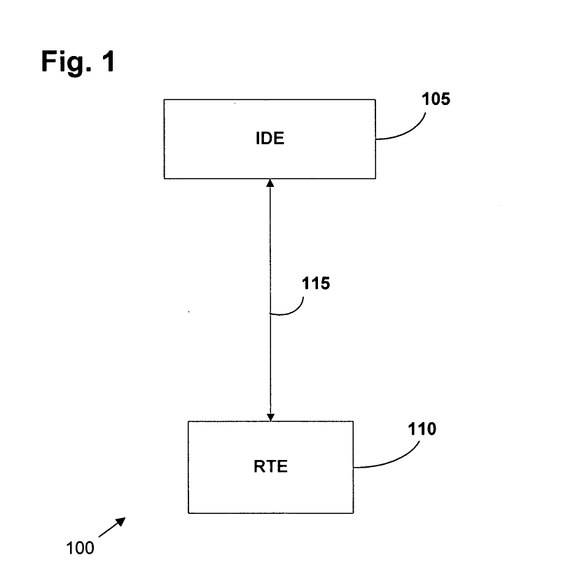

Referring now to FIG. 1, an example schematic representation of a learning model-based lifecycle system 100 is illustrated. An IDE 105 includes a set of software tools linked within the IDE 105. A RTE 110 includes another set of software agents linked within the RTE 110. The IDE 105 and the RTE 110 are linked via link 115.

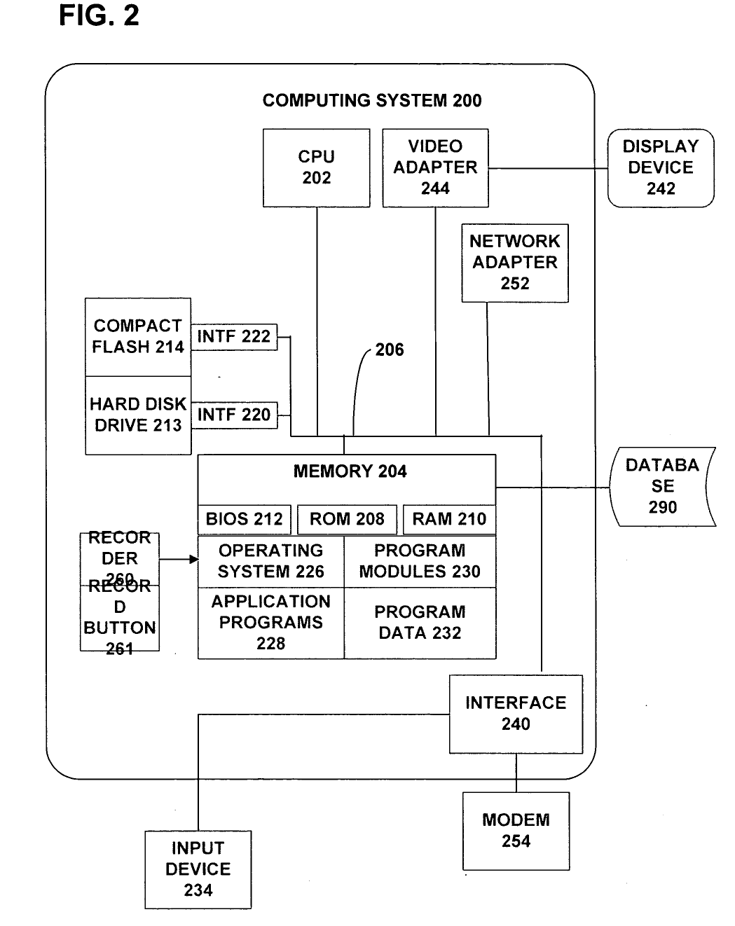

FIG. 2 and the following discussion are intended to provide a brief, general description of a suitable computing environment in which the invention might be implemented. Although not required, the invention is described in the general context of computer-executable instructions, such as program modules, being executed by a computing system. Generally, program modules include routines, programs, objects, components, data structures, etc. that perform particular tasks or implement particular abstract data types.

Those skilled in the art will appreciate that the invention might be practiced with other computer system configurations, including handheld devices, palm devices, multiprocessor systems, microprocessor-based or programmable consumer electronics, network personal computers, minicomputers, mainframe computers, and the like. The invention might also be practiced in distributed computing environments where tasks are performed by remote processing devices that are linked through a communications network. In a distributed computing environment, program modules might be located in both local and remote memory storage devices.

Referring now to FIG. 2, an exemplary environment for implementing embodiments of the present invention includes a general purpose computing device in the form of a computing system 200, including at least one processing system 202. A variety of processing units are available from a variety of manufacturers, for example, Intel or Advanced Micro Devices. The computing system 200 also includes a system memory 204, and a system bus 206 that couples various system components including the system memory 204 to the processing unit 202. The system bus 206 might be any of several types of bus structures including a memory bus, or memory controller; a peripheral bus; and a local bus using any of a variety of bus architectures.

Preferably, the system memory 204 includes read only memory (ROM) 208 and random access memory (RAM) 210. A basic input/output system 212 (BIOS), containing the basic routines that help transfer information between elements within the computing system 200, such as during start-up, is typically stored in the ROM 208.

Preferably, the computing system 200 further includes a secondary storage device 213, such as a hard disk drive, for reading from and writing to a hard disk (not shown), and/or a compact flash card 214.

The hard disk drive 213 and compact flash card 214 are connected to the system bus 206 by a hard disk drive interface 220 and a compact flash card interface 222, respectively. The drives and cards and their associated computer-readable media provide nonvolatile storage of computer readable instructions, data structures, program modules and other data for the computing system 200.

Although the exemplary environment described herein employs a hard disk drive 213 and a compact flash card 214, it should be appreciated by those skilled in the art that other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules may be stored on the hard disk 213, compact flash card 214, ROM 208, or RAM 210, including an operating system 226, one or more application programs 228, other program modules 230, and program data 232. A user may enter commands and information into the computing system 200 through an input device 234. Examples of input devices might include a keyboard, mouse, microphone, joystick, game pad, satellite dish, scanner, digital camera, touch screen, and a telephone. These and other input devices are often connected to the processing unit 202 through an interface 240 that is coupled to the system bus 206. These input devices also might be connected by any number of interfaces, such as a parallel port, serial port, game port, or a universal serial bus (USB). A display device 242, such as a monitor or touch screen LCD panel, is also connected to the system bus 206 via an interface, such as a video adapter 244. The display device 242 might be internal or external. In addition to the display device 242, computing systems, in general, typically include other peripheral devices (not shown), such as speakers, printers, and palm devices.

When used in a LAN networking environment, the computing system 200 is connected to the local network through a network interface or adapter 252. When used in a WAN networking environment, such as the Internet, the computing system 200 typically includes a modem 254 or other means, such as a direct connection, for establishing communications over the wide area network. The modem 254, which can be internal or external, is connected to the system bus 206 via the interface 240. In a networked environment, program modules depicted relative to the computing system 200, or portions thereof, may be stored in a remote memory storage device. It will be appreciated that the network connections shown are exemplary and other means of establishing a communications link between the computing systems may be used.

The computing system 200 might also include a recorder 260 connected to the memory 204. The recorder 260 includes a microphone for receiving sound input and is in communication with the memory 204 for buffering and storing the sound input. Preferably, the recorder 260 also includes a record button 261 for activating the microphone and communicating the sound input to the memory 204.

A computing device, such as computing system 200, typically includes at least some form of computer-readable media. Computer readable media can be any available media that can be accessed by the computing system 200. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 200.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

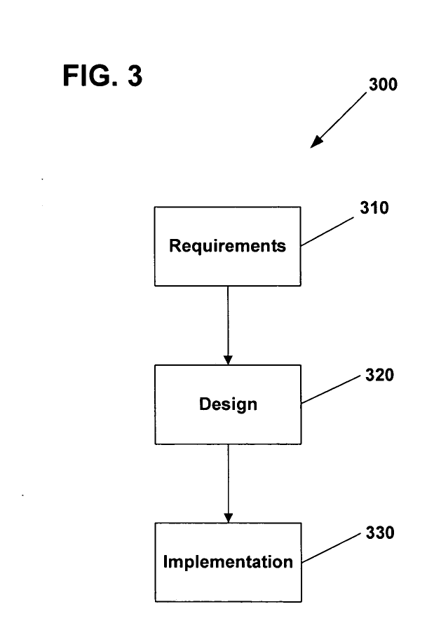

FIG. 3 is a block diagram illustrating a development system 300, which can include software and development tools. The development system 300 includes three basic types of components in the development of a product, for example, a vehicle. Block 310 is the requirements component. The first step in product and system development uses the requirements component. The requirements component defines what the product and system will include. Block 320 is the design component. After the requirements for the product and system are determined, the product and system are designed to conform to those requirements. Block 330 is the implementation component. After the product and system are designed, the product and system are manufactured according to the design component and put into service. The system can also include enterprise applications for supply and service chain integration. In addition, the system can include run-time application services including telecommunications and operations infrastructure and vehicles.

Using a vehicle as an example, a car manufacturer decides to make a new model X car with systems for learning model-based lifecycle diagnostics. At block 310, the requirements for the X car and systems are determined. For example, the X car should be a sedan having a certain payload, acceleration, and should not exceed $20,000. The system should reduce warranty repair costs and improve customer satisfaction.

At block 320, the X car and the systems are designed according to those requirements. The frame and suspension of the car are designed to carry the required payload, the power train is designed or chosen based on the gross vehicle weight and the acceleration requirement, and the rest of the X car is designed to not exceed $20,000. For example, knowing the X car should not exceed $20,000, an engineer may decide to choose an engine that barely meets the acceleration requirement and would not choose an engine that would greatly exceed the acceleration requirement. The system should be designed using web services with an imbedded web platform to run on a three-tier architecture consisting of servers, telematics, and electronics embedded in the vehicle. The system can have a distributed database to enable servers to be located throughout the supply and service chain. The system can include development, manufacturing, and service tools.

At block 330, the X car and the systems are implemented, i.e. manufactured and put into service, according to the design. Implementation deploys the software and hardware throughout the three-tier architecture in the supply and service chains.

Typically, software is utilized in each step of the product and system lifecycle, which includes product and system development, production, and service. Requirements management (RM) processes of vehicles and systems requires tools to facilitate collaboration among people in the supply and service chain. Currently, requirements management (RM) software uses model-driven, objected-oriented (OO) tools based on information authored and collected by people. Since the RM is dependant on the information input into it, the RM is limited. Therefore, these typical RM tools are inflexible and cannot autonomously recognize errors without intervention from people. Some RM tools are based on knowledge agents, giving it the ability to learn and recognize errors. Such RM tools are also flexible.

In the requirements step, there are two classes of knowledge problems that determine the type of product and system to be analyzed, and then the tools and processes required for development, production, and service. These two classes of problems include “tame” and “wicked” problems. Most problems are tame and can be solved with a stage-gate, linear process and information-based tools. Developing the requirements for a system to manage wicked problems requires a spiral process and knowledge-based tools.

Wicked problems are composed of a linked set of issues and constraints, and do not have a definitive statement of the problem itself. The problem (and therefore the requirements for designing a solution) cannot be adequately understood until iterative prototypes representing solution candidates have been developed. Within the primary overall development process, which is linear, a secondary spiral process for iterative prototypes is required. The spiral process involves “rolling out” a portion of the software at a time while another portion is being developed. The software engineering community has recognized that a spiral process is essential for rapid, effective development.

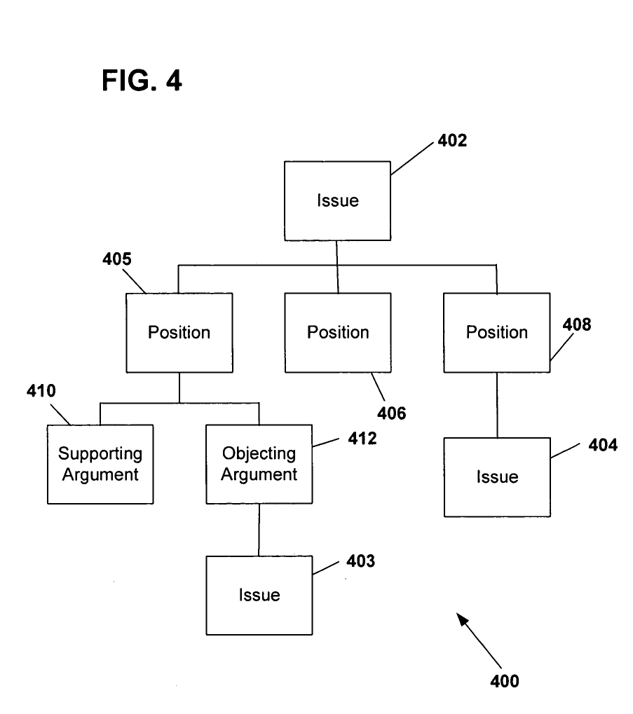

An example of a wicked problem is the design of a car and the diagnostics for the car. The “wicked” terminology was introduced by Horst Rittel in 1970. Rittel invented a technology called issue-based information systems (IBIS) to help solve this new class of problems. Wicked problems look very similar to ill-structured problems, but have many stakeholders whose views on the problem may vary. Wicked problems must be analyzed using a spiral, iterative process, and the ideas, such as requirements associated with the problem, have to be linked in a new paradigm 400, illustrated in FIG. 4.

Referring to FIG. 4, the three key IBIS entities are (1) issues 402, 403, 404, or questions, (2) positions 405, 406, 408, or ideas that offer possible solutions or explanations of the issues, and (3) arguments 410, 412, or the pro's and con's. All three entities can be linked by relationships such as supports, objects-to, is—suggested—by, responds to, generalizes, specializes, replaces, and others. The visualization of IBIS becomes a graph or a network. IBIS builds a bridge between design and argumentation or the expressed dialog of ideas that forms the core of knowledge management.

IBIS is a graphical language with a grammar, or a form of argument mapping. Applying IBIS requires a skill similar to the design of experiments (DOE). Jeffrey Conklin (http://cognexus.org/id17.htm) pioneered the application of graphical hypertext views for IBIS structures with the introduction of graphical IBIS or gIBIS. The strength of IBIS, according to Conklin, stems from three properties: (1) IBIS maps complex thinking into analytical structured diagrams, (2) IBIS exposes the questions that form the foundation of knowledge, and (3) IBIS diagrams are much easier to understand than other forms of information.

Compsim LLC has extended IBIS in several ways. In their IBIS tool architecture, ideas can be specified in either the form of a text outline or a tree structure of nodes. Ideas of a given level can have priorities and weights to change the ordering of the display of ideas. Priorities can be easily edited in a variety of graphical ways. A unique decision making mechanism mimics human thinking with relative additions and subtractions for supporting negating arguments. The IBIS logic is captured as XML definitions and is used to build linked networks of knowledge-based agent networks. Compsim calls this agent structure knowledge enhanced electronic logic (KEEL). The agents execute an extended form of the IBIS logic.

The current field that contains IBIS is called computer-supported argument visualization (CSAV). Related fields that apply CSAV are computer-supported cooperative work (CSCW) and computer-mediated communication (CMC), which helped spawn the Internet. CMC tools include Microsoft's NetMeeting™ product.

Argument visualization is a key technology for defining the complex relationships found in requirements management, which is a subset of knowledge management (KM). One of the principles for KM is found in constructivist learning theory, which requires the negotiated construction of knowledge through collaborative dialog. The negotiation involves comparative testing of ideas. The corresponding dialog with visualization of ideas creates the tacit knowledge that comprises the largest part of knowledge as opposed to the explicit part of knowledge directly linked to information. Tacit knowledge is essential for shared understanding.

IBIS is a knowledge-based technology. IBIS tools for requirements management such as Compenium™ or QuestMap™ (trademarks of GDSS, Inc.) are distinctly different from object-oriented (OO) framework tools for RM such as Telelogics's DoorS™ or IBM's Requisite-Pro™. Wicked problems cannot be easily defined such that all stakeholders agree on the problem or the issues to be solved. There are tradeoffs that cannot be easily expressed in OO framework with RM tools. IBIS allows dyadic, situated scenarios to define requirements. IBIS allows the requirements to be simulated. IBIS can sense those situations and determine which set of requirements is appropriate or whether the requirements even adequately apply to the situation.

In summary, current RM tools have limitations. OO RM tools enable traceability between requirements, design, and implementation during development, but not during the production or service deployment phases. OO RM tools are not knowledge-based and cannot easily handle ill-structured, wicked problems with multiple stakeholder views that conflict with different weighted priority ranking of those views expressed as the pro's and con's of argumentation. IBIS RM tools overcome most of those limitations but do not develop traceable requirements for a system design.

Both OO RM and IBIS RM tools recognize that the relationship between ideas as expressed in text alone is not clear without additional structure such as an outline with an associated hierarchy. Network structures such as those made possible by hypertext technology can be traced back to Vannevar Bush and his 1945 article As We May Think. In 1962, Douglas Englebart defined a framework for cognitive augmentation with tools in his report from the Stanford Research Institute, Augmenting Human Intellect: A Conceptual Framework. The result of Englebart's research and development work was the development of the modem windows, icon, mouse, and pointer (WIMPT) graphical user interface (GUI) and an early implementation of hypertext-based tools.

Round-trip engineering for OO, or model-driven software development, is source code for implementation that is traceable back to elements of design and requirements. The round-trip is between requirements, design, and implementation as source code and then back to design and requirements. Since round-trip engineering currently occurs only during development and only within certain segments of the IDE, model errors that appear in the RTE after development cannot be traced back to root causes in requirements, design, or implementation. A segmented IDE might consist of four quadrants. These quadrants contain methods and tools for (1) enterprise applications in a system, (2) embedded software for the vehicles, (3) telematics for the vehicle, and (4) service systems for the vehicle.

Frequently, the OO model is defined using an unified modeling language (UML). UML is a third generation OO graphical modeling language. The system model has structural, behavioral, and functional aspects that interact with external users called actors as defined in use cases. A use case is a named capability of the system. System requirements typically fall into two categories: functional requirements and non-functional or Quality of Service (QoS) requirements.

Functional means what the system should do. QoS means how well or the performance attributes of the function. In common usage, functional can imply both functional and performance. The structural aspect defines the objects and object relations that may exist at run-time. Subsystems, packages, and components also define optional structural aspects. The behavioral aspect defines how the structural elements operate in the run-time system. UML provides state-charts (formal representation of finite-state-machines) and activity diagrams to specify actions and allowed sequencing. A common use of activity charts is specifying computational algorithms. Collections of structural elements work together over time as interactions. Interactions are defined in sequence or collaboration diagrams.

The requirements of a system consisting of functional and QoS aspects are captured typically as either one or both of two ways: (1) a model is use cases with detailed requirements defined in state charts and interaction diagrams, or (2) specifications as text with or without formal diagrams such as sequence diagrams that attempt to define all possible scenarios of system behavior.

Round-trip engineering traces OO requirements through OO design into an OO implementation that includes the OO source code for software. This round-trip occurs only in certain segments of the IDE, which are OO IDE segments, and only during development. Currently, there is no round-trip traceability between an RTE and an IDE during development, production, and service. Round-trip engineering has been extended to use a meta-model rather than require obtrusive source code markers, but extended round-trip engineering still occurs only within certain segments of the IDE during development.

Model-based diagnostics is a state-of-the-art method for fault isolation, which is a process for identifying a faulty component or components of a vehicle and a system that is not operating properly in compliance with operating parameters specified as part of the vehicle and system's implementation model. Model-based diagnostics suffers from the limitations of assuming that the model has no errors and accurately represents all the operating scenarios of the system. The operating scenarios of the system include all expected faults.

If an adequate amount of observable information from the vehicle is available at run-time, model-based diagnostics can determine the root cause for previously known and expected failure modes predicted by an expanded model that includes both normal and failure modes. The expanded model is used to simulate and record the behavior resulting from all possible single component failures, then combinations of multiple component failures. When failure behavior is observed, a sequence of pre-determined experiments can be performed to determine the root cause.

Faults in the vehicle and system's requirements or design and implementation models are mainly detected after development by users who may complain and have their complaints analyzed by service technicians and then possibly by engineers. Situations that led to the complaints are frequently not easily identified and reproducible. The process of fault isolation or root cause determination generally begins at detection of abnormal system behavior and attempts to identify the defective and improperly operating component or components. These components perform some collection of functions in the system. The components are frequently designed to be field replaceable hardware units that may contain software. However, the failure model assumed in current practice considers functional failure modes of the replaceable component and does not determine whether the failure inside the component or components is a hardware or a software failure. If the failure is in software, then the failure is a model failure at the requirements, design, or implementation level. Replacing the hardware component or components will not repair the problem.

In one example embodiment, an improved method and system of detecting lifecycle failures in vehicle functional subsystems, that are caused either by hardware failures or by model errors in requirements, design, or implementation and tracing the failure back to the root cause in the model, is contemplated. For tracing, the method uses a new capability for lifecycle round-trip engineering that links diagnostic agents in the RTE with a dyadic model in the IDE for managing the development and maintenance of vehicle functions and the corresponding diagnostics. The dyadic model in the IDE is managed by linked dyadic tools that develop functions and corresponding diagnostics at each level of the spiral development “V” process (which will be described in more detail later): requirements, design and implementation. The lifecycle diagnostic method, which links the IDE and RTE, can be applied during development, production, and service of the vehicle RTE.

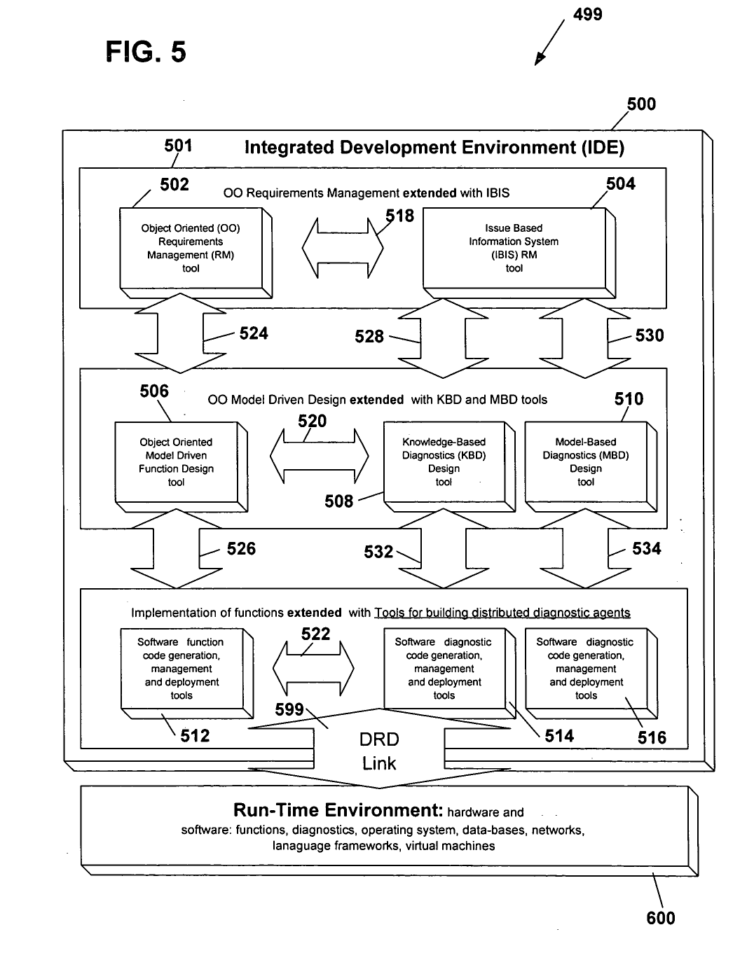

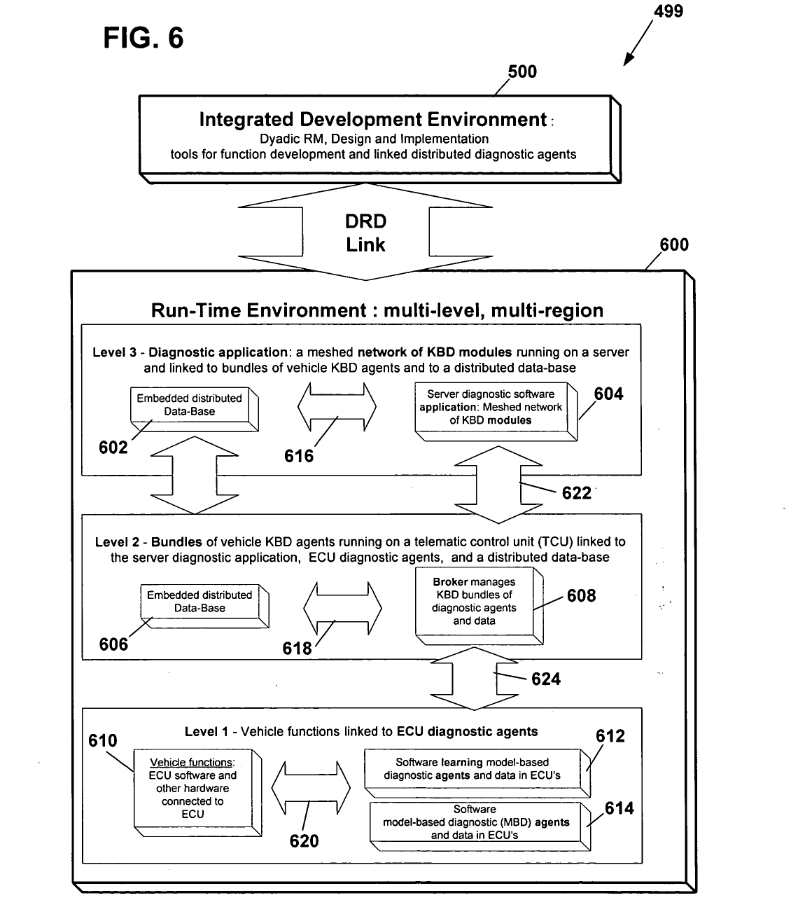

Referring to FIGS. 5 and 6, a learning model-based lifecycle diagnostic system 499 is illustrated. Preferably, the system 499 includes an IDE 500 and a RTE 600 linked by a DRD link 599. FIG. 5 is a system diagram, according to one example embodiment, for a lifecycle diagnostic method for the development of vehicle functions and corresponding diagnostics in the IDE 500 and the deployment of diagnostics in an RTE 600 to service vehicles. The diagram illustrates how the lifecycle method links development tools together in the IDE 500 with linkages. The IDE 500 in the lifecycle method contains development tools and processes to develop vehicle functions and a corresponding diagnostic application consisting of a set of integrated and linked diagnostic agents for deployment in the RTE 600. The IDE 500 and the RTE 600 are linked through a DRD link 599 and corresponding processes. The DRD 599 can include a database, which can be a distributed data base.

FIG. 6 is a system diagram, according to one example embodiment, for a lifecycle diagnostic method for the development of diagnostics in an IDE 500 and the deployment of diagnostics in a RTE 600 to service vehicles. The diagram illustrates how the lifecycle method links diagnostic agents together in the RTE 600 with linkages. The RTE 600 in the lifecycle method contains and operates the diagnostic application deployed as a three level system consisting of diagnostic agents, running on servers, TCUs, or equivalent modules that plug into vehicles, and ECU's. Production Service tools interface to the vehicle and are part of the RTE 600. The RTE 600 is linked back to the IDE 500 through the DRD link 599 and corresponding processes.

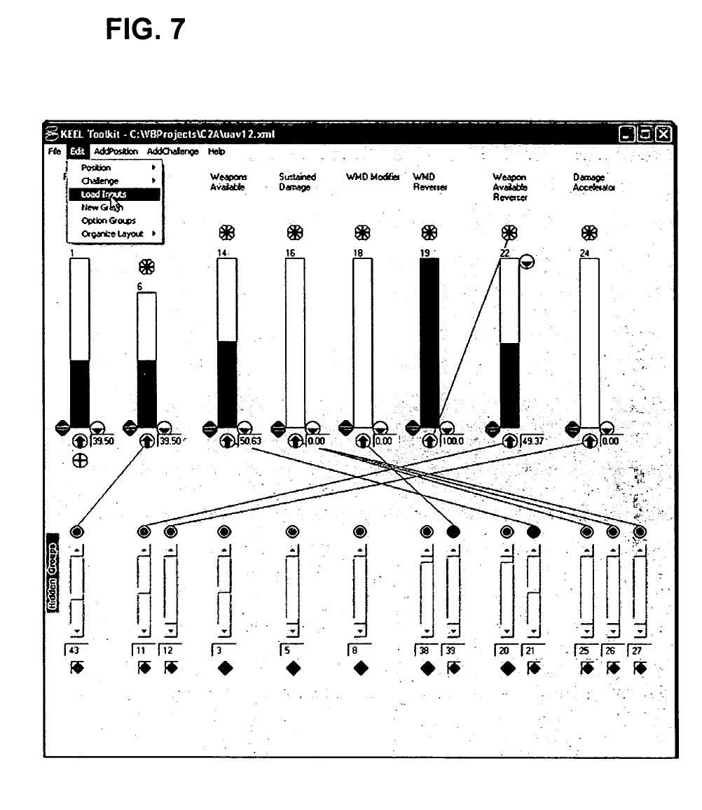

As shown in FIG. 7, an IDE tool such as the Compsim KEEL toolkit can be driven by the data returned in the DRD link 499, FIG. 5, to simulate and test the design model and analyze the failure mode. The data shown below is an example of the input schema defined in XML by the IDE 500, FIG. 5; the schema is stored in the DRD link 599:

- <Schema name=“KEELDataSchemaxml” xmlns=“urn:schemas-
microsoft-com:xml-data” xmlns:dt=“urn:schemas-microsoft-
com:datatypes”>
<ElementType name=“Index” dt:type=“ui2” />
<ElementType name=“Value” dt:type=“float” />
- <ElementType name=“InDat” content=“eltOnly” model=“closed”>
<element type=“Index” minOccurs=“1” />
<element type=“Value” minOccurs=“1” />
</ElementType>
<ElementType name=“ProjectTitle” content=“textOnly”
model=“closed” dt:type=“string” />
- <ElementType name=“Report” content=“eltOnly” model=“closed”>
<element type=“ProjectTitle” minOccurs=“1” />
<element type=“InDat” minOccurs=“0” maxOccurs=“*” />
</ElementType>
</Schema>

The DRD link 599 eliminates the need for the RTE agents 600 to know how to communicate with the tools in the IDE 500. The system 499 creates the proper linkages between the IDE 500 and the RTE 600 using only the information in the DRD link 599. An example of the data returning from the RTE 600 to the IDE 500 is shown below:

<?xml version=“1.0” ?>
- <Report xmlns=“x-schema:KEELDataSchemaxml.xml”>
<ProjectTitle>UAV1</ProjectTitle>
- <InDat>
<Index>0</Index>
<Value>100</Value>
</InDat>
- <InDat>
<Index>1</Index>
<Value>22</Value>
</InDat>
- <InDat>
<Index>2</Index>
<Value>82</Value>
</InDat>
- <InDat>
<Index>3</Index>
<Value>60</Value>
</InDat>
- <InDat>
<Index>4</Index>
<Value>64</Value>
</InDat>
- <InDat>
</Report>

Referring back to FIG. 5, preferably, the IDE 500 has three levels of development activity for users of the system 499 with corresponding tools and processes. These three levels are requirements management, design, and implementation. The system 499 creates a linked dyadic tool pair for functions and diagnostics at each level in the IDE 500.

At the top of FIG. 5 is the activity called requirements management. Typical model-driven, object-oriented (OO) development tools for requirements management (RM) are IBM/Rational Requisite Pro™ and Telelogic DOORS™. The lifecycle method creates a new dyadic capability for RM by augmenting existing OO RM tools with an issue-based information (IBIS) tool such as the Compsim Management Tool™ (CMT).

The IDE 500 includes a first RM 502, a second RM 504, a first design tool 506, a second design tool 508, a third design tool 510, a first deployment tool 512, a second deployment tool 514, and a third deployment tool 516. Preferably, the first RM 502 is implemented as OO RM Tool, and the second RM 504 is implemented as an IBIS RM Tool. The first design tool 506 is implemented as an OO model-driven function design tool, such as IBM/Rational Rose™, iLogix's Rhapsody™, the MathWorks's Simulink™ or ETAS's ASCET/SD™.

The second design tool 508 is implemented as a knowledge-based diagnostics design tool. The third design tool 510 is implemented as a model-based diagnostics design tool. The second design tool 508 and the third design tool 510 comprise a diagnostic builder tool suite that contains both knowledge-based diagnostic design tools and model-based diagnostic design tools. These tools enable the user of the system 499 to develop run-time diagnostic agents for the corresponding designed vehicle functions. The diagnostic agents are intended to run on the three levels of the RTE 600, FIG. 6. The diagnostic builder suite specifies the targeted level of the RTE 600 for each diagnostic agent and builds the links shown in FIG. 6 between the agents in the RTE 600. An example of a knowledge-based agent development tool is Compsim's KEEL™. An example of a model-based agent development tools is R.O.S.E. 's Rodon™.

The first deployment tool 512 is implemented as a software function code generation, management, and deployment tools such as ASCET/SD™. The second deployment tool 514 is implemented as a software diagnostic code generation, management, and deployment tool. And, the third deployment tool 516 is implemented as a software diagnostic code generation, management, and deployment tool.

The first RM 502 is linked to the second RM 504 via link 518. The link 518 is any standard communication link known in the art. The link 518 is a bi-directional, integrated link that enables capturing the knowledge, assumption, and decision logic behind the requirements captured in the first RM 502. Preferably, the system 499 implements link 518 by passing unique XML function identifier descriptors (FIDs-RM) for objects in the first RM 502 to the second RM 504 and by building a data relationship with XML diagnostic identifier descriptors (DIDs-RM). The dyadic relationship for link 518 is stored in the DRD link 599. By windowing the second RM 504 into the graphic user interface of the first RM 502, the system 499 enables the user to define the decision logic behind the requirement being captured as objects in the first RM 502, such as a use case. The logic in the second RM 504, corresponding to the object in the first RM 502, is defined as unique XML diagnostic identifier descriptors (DIDs).

The first design tool 506 is linked to the second and third design tools 508, 510 via link 520. Link 520 bi-directionally passes unique XML defined function identifier descriptors for design (-D) and diagnostic identifier descriptors for design (-D) and integrates the graphical user interface of the separate tools at the design level.

The first deployment tool 512, or functional module, is linked to the second and third deployment tools 514, 516, or diagnostic agents, via link 522. Link 522 bi-directionally passes unique XML defined function identifier descriptors for implementation (-I) and diagnostic identifier descriptors (-I) and integrates the graphic user interface of the implementation tools. Link 522 is implemented by defining the ECU memory locations and data types for the information corresponding to vehicle modules. ASAM MCD™ with XML is an example of such a link. Tools, such as ETAS's ASCET/SD™ and INCA™, can be used to implement link 522.

The first RM 502 is also linked to the first design tool 506 via link 524. The first design tool 506 is also linked to the first deployment tool 512 via link 526 for implementation. Links 524, 526 enable what is called round-trip engineering for functions in the development environment. Objects corresponding to requirements can be traced through design to the source code in implementation and back up to design and requirements.

Likewise, the second RM tool 504 is linked to the second and third design tools 508, 510 via links 528, 530, respectively. The second and third design tools 508, 510 are linked to the second and third deployment tools 514, 516 via links 532, 534, respectively. Links 532, 534 enable round-trip engineering for diagnostics in the development environment. XML defined design objects for diagnostics are linked to source code for diagnostics.

The system 499 integrates model-based diagnostic design tools, such as R.O.S.E's Rodon™, that generate source code with tools, such as ASCET/SD™, to generate executable code on a real-time operating system for implementation on the RTE 600, FIG. 6.

Referring to FIG. 6, the RTE 600 has three levels of software and hardware. Using the tools in the IDE 500, the DRD Link 599, and processes, the system 499 enables the building of a diagnostic application as a collection of linked diagnostic agents that run on the three levels. Some of the agents can be downloaded onto level 2 using OSGi™.

The RTE 600 includes a first database 602, a server application 604, a second database 606, a broker 608, an electronic control unit (ECU) 610, learning agents 612, and agents 614. Preferably, the first database 602 is an embedded distributed data-base known in the art. The server application 604 is a server diagnostic software application and meshed network of KBD modules. The second database 606 is an embedded distributed data-base. The broker 608 manages KBD bundles of diagnostic agents and data. The ECU 610 includes software and other hardware connected to the ECU. The learning agents 612 include software learning model-based diagnostic agents and data in ECU's. The agents 614 include software model-based diagnostic (MBD) agents and data in ECU's.

The first database 602 is linked to the server application 604 via link 616. The second database 606 is linked to the broker 608 via link 618. The ECU 610 is linked to the learning agents and the agents via link 620. The server application 604 is also linked to the broker 608 via link 622. The broker 608 is linked to the learning agents 612 and agents 614 via link 624.

The IDE 500 and RTE 600 are linked via link 599. Link 599 is a Development, Run-time, Development (DRD) link. Preferably, the DRD link 599 is implemented using a telecommunications and operations infrastructure (TOI) containing combinations of a distributed data-base and software interprocess communication (IPC) mechanisms. In the DRD link 599, the information sent through the data-base or FPC mechanisms are defined by XML schemas and contain both IDE 500 and RTE 600 data. The XML schema could be sent in messages or optionally be used to configure a distributed data-base.

During development, new diagnostic tools in the IDE 500 are used to guide users to follow a spiral “V” process “down” and “up” the “V” to build IDE model linkages (as is described in more detail below) between functions uniquely identified with function identifier descriptors (FIDs) and corresponding diagnostics uniquely identified with diagnostic identifier descriptors (DIDs) at the levels of requirements, design, and implementation. The IDE dyadic (function-diagnostic) model linkages with FIDs and DIDs are stored in the DRD link 599 data-base.

Consequently as the method follows the spiral “V” process over iterative prototyping cycles during development, a new dyadic system model is built in the IDE 500 and the DRD link data-base 599. An RTE 600 is also built for the vehicle. The RTE 600 contains a three-tier level of diagnostic agents that are linked together into an integrated diagnostic application architecture (DAA) and linked to the vehicle functions including software with corresponding calibration parameters in ECU's.

The three-tier RTE 600 includes managers on the servers 604 and brokers 608 on the TCUs for dynamically deploying the agents 612, 614 onto vehicles such as downloading agents to a vehicle's TCU or a vehicle service module (VSM).

In the RTE 600, run-time linkages or run-time binding between software objects is performed by the agent manager and brokers using the IDE defined XML schemas and data such as the FIDs and DIDs contained in the DRD link 599. This enables linking agents together and linking agents with functions.

An example of the linking is connecting a diagnostic agent with a calibration parameter in an engine ECU. In an IDE 500 using UML, these connections might also include ports and protocols. In an IDE 500 and a RTE 600 complying with the Association for Standardization of Automation and Measurement (ASAM), additional access methods for measurement, calibration and diagnosis (MCD) that relate to ECU's in vehicles would be defined. These access methods would still be contained in the DRD link 599 and represented as XML schemas with embedded data.

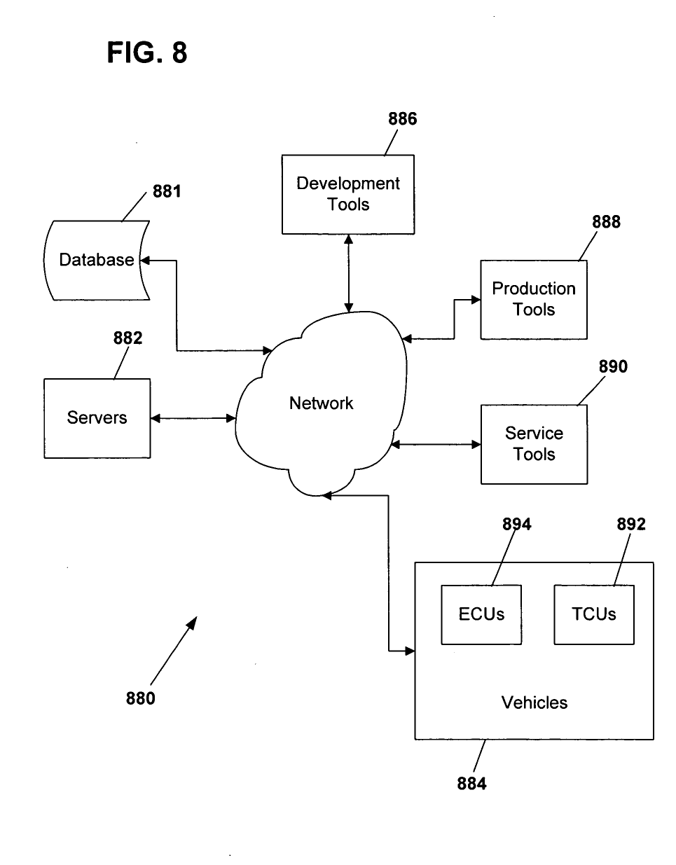

Referring to FIG. 8, the lifecycle diagnostic method manages vehicles in a distributed system 880. The distributed system include a database, 881, servers 882, vehicles 884, tools for development, production and service, 886, 888, 890 and modules inside the vehicle such as TCUs 892 and ECUs 894. The architecture that the method uses to define the system is the ISO Open System Interconnection (OSI) seven layer reference model. The layers are application, presentation, session, transport, network, data link, and physical. The DAA comprises the top three layers of the seven layer “stack” for a node, and the TOI comprises the bottom four layers of the stack.

Root cause tracing occurs with lifecycle round-trip engineering that links the detected failures in the vehicle RTE 600, FIG. 6, with the elements of the model in the IDE 500, FIG. 5. The linkage is implemented by using the IDE 500 linkages stored in the data-base. By tracing the linkages built with tools in an IDE 500, the candidates for root cause in requirements, design, and implementation can be determined.

A spiral lifecycle process is triggered by the likely detection of failures by cooperative, autonomous diagnostic agents in the vehicle RTE 600, FIG. 6. The agents would apply a range of algorithms and technologies that can be classified in several categories: model-based diagnostics (MBD), learning model-based diagnostics (LMBD) or knowledge based diagnostics (KBD). Current OBD diagnostic agents use MBD that frequently applies exponential moving averages, which are first order Kalman filters, to design acceptable Type 1 and Type 2 statistical error profiles.

The trigger can be assisted by service tools connected to the vehicle RTE 600. FIG. 6. The trigger sends information through messages or a distributed data-base to the vehicle's diagnostic application running on one or more servers. The messages or data-base transactions from the vehicle to the server(s) are created by the vehicle's TCU after being fed information from a combination of MBD and LMBD agents running in ECU's and a combination of MBD, LMBD, and KBD agents running in the TCU.

LMBD agents can apply time-frequency based performance assessment technology to avoid using a model (with errors) for filtering and detection of a signal as a failure. Time-frequency analysis (TFA) provides a method for managing a combined time-frequency representation of a signal or a set of signals that represent the normal behavior of a system. The behavior can vary over time and frequency. TFA is a method for detecting both slow degradation and abrupt failures. Newly developed TFA methods can identify the behavior of a system's signature in ways that are difficult or impossible using time-series or spectral analysis. Optimal design methods for TFA include the Reduced Interference Distribution or RID. RID optimization achieves the goal of providing high resolution time-frequency representations. Learning MBD agents built with RID TFA technology exhibit many desirable properties such as very rapid identification of failures without using a model, with minimal processing and with engineered statistical confidence in the detection.

Referring back to FIGS. 5 and 6, preferably, a learning model-based lifecycle diagnostics system 499 includes an IDE 500, linkages within the IDE between EDE tools, an RTE 600, linkages within the RTE 600, and a DRD link 599. These linkages, operating with agents and tools in the RTE 600 and tools in the IDE 500, enable the system to trace failures detected in the RTE back to the root cause as model errors in the IDE.

To trace model failures back from the RTE 600 to the IDE 500, the method implements round-trip engineering between diagnostic agents in the RTE 600 and diagnostics linked to the corresponding vehicle functions in the IDE 500. The functions are represented as a model with objects. Because the agents, processes, tools, and linkages operate together in a spiral process to learn model errors over a vehicle's lifecycle, the method is called lifecycle learning-model based diagnostics.

An IDE 500 is an integral part of the lifecycle method in addition to a RTE 600 for software on the vehicle and software that supports the production and service of the vehicle. Service of the vehicle includes service operations at dealers and a telematic service such as OnStar™. Preferably, the RTE 600 includes fleets of vehicles, the electronic control units (ECU's), networks, sensors, actuators and user interface devices such as speedometers on dashboards on individual vehicles, and a telecommunications and operations infrastructure (TOI) that includes computers such as distributed servers, communication networks such as cellular and wireless LAN's such as WIFI, and tools such as diagnostic scan tools generally found at OEM dealerships and independent aftermarket (IAM) repair shops.

Preferably, the IDE 500 is a computing laboratory and experimental driving environment with a collection of development tools for developing and maintaining vehicle functions such as power train electronics, including the ECU's, sensors, and actuators for an engine and transmission, body electronics, such as the ECU's, sensors, and actuators for lighting systems, and chassis electronics, such as the ECU's, sensors, and actuators for anti-skid braking systems (ABS). The vehicle functions are implemented in systems such as power train and corresponding subsystems, such as engine cooling. These systems and subsystems include both hardware and software. The IDE 500 is also used to develop the enterprise application software (alternately called the information technology or IT software) to support vehicle production and service operations.

The software that implements vehicle functions generally runs on electronic control units (ECU's) and an optional telematic control unit (TCU) residing on the vehicle. The application software runs on computers such as servers and PC's and for service tools such as diagnostic scan tools. The development of vehicle diagnostic software for service operations is commonly called authoring. The diagnostic software on the vehicle is called on-board diagnostics (OBD).

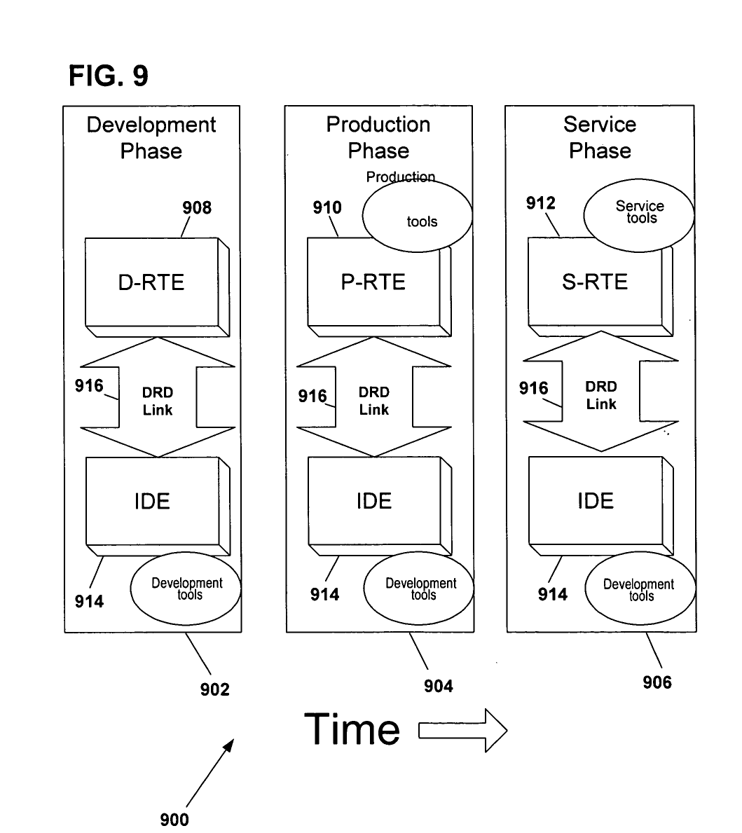

The processes used in the methods of the IDE 500, FIG. 5, are illustrated in FIGS. 9-18. As these processes are followed, the linked tools in the IDE 500 build information in the DRD 599 to link the diagnostic application and agents in the RTE 600 with the IDE 500. Those agents read the DRD 599 to find FIDs linked with DIDs.

FIG. 9 is a process diagram illustrating a vehicle product development lifecycle 900, according to an exemplary embodiment of the present disclosure. The product development process for a specific model year of a vehicle over its lifecycle is conceptually divided into three phases including a development phase 902, a production phase 904, and a service phase 906. Development, production and service activities require the management of large amounts of software. Software creates a major part of the vehicle function and a major part of a business information system to support the vehicle's lifecycle.

Development of a production and service capability including the tools for production and service occurs during the development phase 902. Capability is defined as people with knowledge, tools, technology, and processes. There is an associated architecture that represents the structure of the capability, including a business information system, represented by tools and technology. There is a large amount of software in the business system. The associated architecture also includes the structure of the vehicle, including its subsystems, that include its on-board information system. There is also a board diagnostic (OBD) system in the vehicle. This OBD system includes a large amount of software. Part of the OBD system is required by government regulations to indirectly monitor the vehicle's emissions by monitoring the operation of the vehicle's emission control systems. Typically, there is almost as much diagnostic software in a vehicle's power train ECUs as there is control software.

The information system on the vehicle typically includes many electronic control units (ECUs). Vehicles typically have fifty or more ECUs. These ECUs contain a large amount of software. The architecture of a vehicle, and its production and service systems, are completely defined during development. The development phase 902 typically begins with a large part of the architecture previously determined in a research and development (R&D) phase (not shown) that precedes the development phase 902. The architectural model for a vehicle model is typically derived from a platform model, which includes power train, chassis body, and other subsystem components.

The product development process enables development, production, and service of both the vehicle and the business system as a product. The process operates with the corresponding business system that supports the vehicle during development, production, and service.

The product and the business system are supported by the process, which is part of an organizational capability. The capability has an associated architecture. The architecture relates to both the vehicle and the business system. The capability includes internal and external (outsourced) services with people and their knowledge, applications, tools, platforms, components, and technology. The capability supports the vehicle as a product and the business system in the supply and service chains. These chains support the original equipment manufacturer (OEM) and the vehicle as a product over the lifecycle.

The lifecycle for a vehicle typically lasts more than ten years. The development phase 902 is about two to three years, followed by several years of the production phase 904 for several model years. The production phase 904 is followed by many years of the service phase 906. The initial part of the service phase 906 for a specific vehicle typically includes an original equipment service (OES) warranty period of three or more years that is followed by a service period that includes the independent aftermarket (LAM).

These development, production, and service phases 902, 904, 906 are illustrated as following each other sequentially over time, but there is overlap that will be illustrated in subsequent figures. The production phase 904 begins with the start of production (SOP). The service phase 906 begins with the first customer shipment (FCS) of a vehicle. As many vehicles are produced for a model year, the production and service phases 904, 906 overlap.

In each phase 902, 904, 906 of the process, there is an RTE and an IDE. The RTE is specific to a phase. D-RTE 908 represents a development-RTE; P-RTE 910 represents a production RTE; and S-RTE 912 represents a service RTE. A manufacturing plant with production tools would be included in the P-RTE 910. An OEM dealer's service department with service tools would be included in the S-RTE 912. A single IDE 914 with development tools is common to all phases and linked to each specific RTE 908, 910, 912. The IDE 914 would typically be applied in the supply and service chains, and in the OEM and its business partners. The specific RTEs 908, 910, 912 are connected to the IDE 914 through a DRD Link 916.

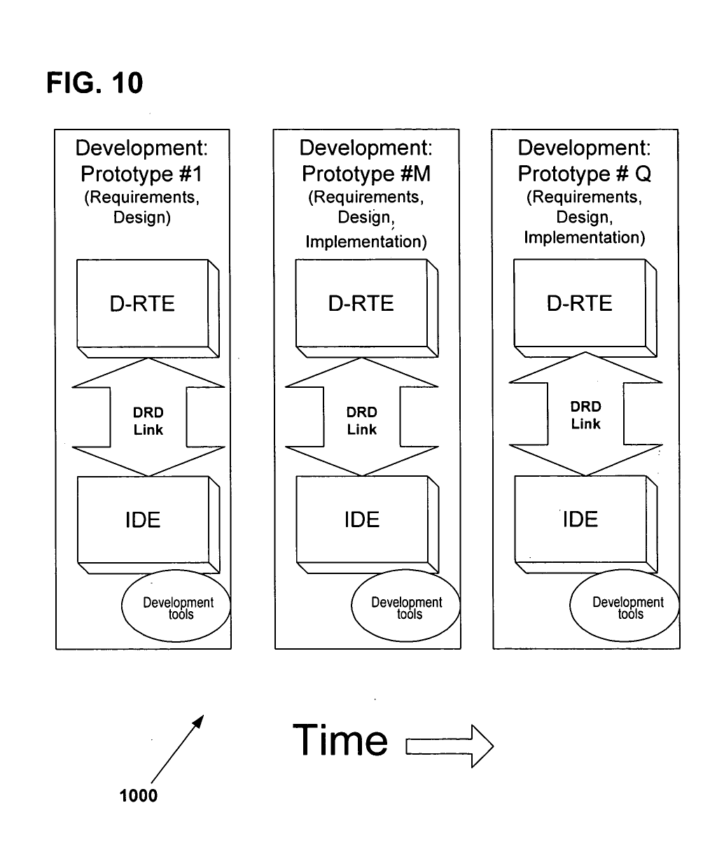

FIG. 10 is a process diagram illustrating the spiral lifecycle process 1000 used during the development phase 902, FIG. 9, of the lifecycle to produce prototype cycles, according to an exemplary embodiment of the present disclosure.

The development phase 902, FIG. 9, of the product development process is used to develop prototypes with a spiral sub process 1000. The sub process 800 fits inside the development phase 902. The vehicle model, and its supporting business system to be developed, consists of components in the categories of requirements, design, and implementation. Development typically begins with an activity to determine and specify some parts of the requirements model for the vehicle and its supporting business system, and then development proceeds to determine and specify some part of the design model for the vehicle and its supporting business system, which includes the RTE with its development, production, and service tools.

Development tools typically support simulation of design models, which enable testing to occur without fully implemented vehicles and supporting systems. Development tools with simulation and testing capabilities such as hardware in the loop (HIL) or software in the loop (SWL) are used to permit incremental development of subsystems before a completed vehicle is available. As development proceeds, some part of an implementation model can be determined and specified. The spiral process is used to incrementally complete parts of requirements, design, and implementation. The spiral process permits repeated forward sequences such as implementation determination and specification that follows design or reverse sequences such as requirements development that follow either design or implementation. Modem software engineering and corresponding tools encourages use of a spiral process during development to speed development, improve quality, and lower development cost.

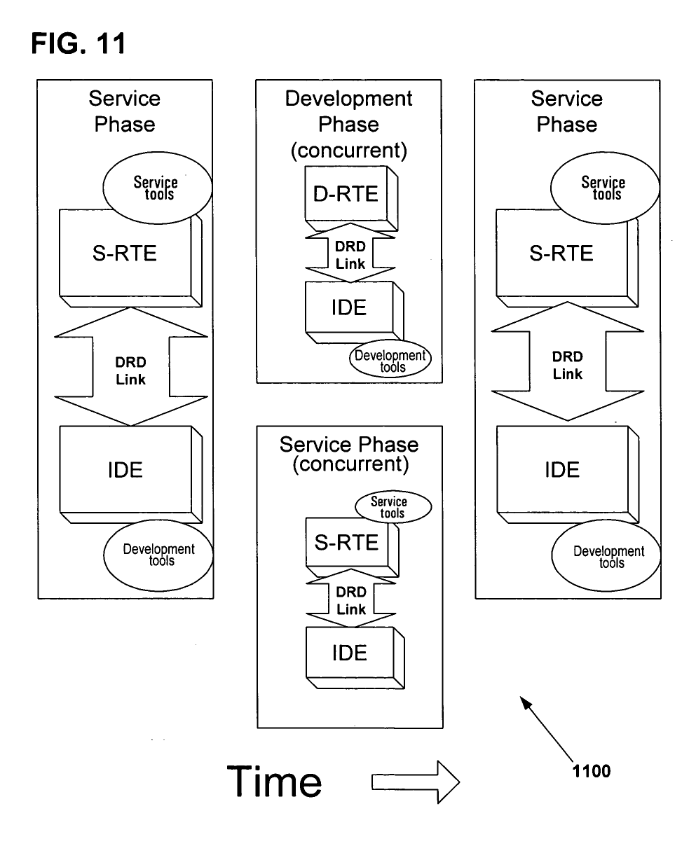

FIG. 11 is a process diagram illustrating the spiral lifecycle process 1100, with periods of concurrent development and service operations, according to an exemplary embodiment of the present disclosure.

The Lifecycle Spiral Process 1100 is required because during the service phase of the vehicle's lifecycle, faults and anomalies will be encountered. Faults are failures that have been previously analyzed and are predicted from a failure mode model. A procedure for determining root cause is probably known and can be effectively applied. Faults can typically be corrected in the field by repair procedures that include swapping or replacing parts.

Anomalies are failures that have not been previously analyzed and are not predicted from a failure mode model. A large part of the anomalies will have root causes in model errors, such as software bugs. Model errors will be found in the implementation of the vehicle and/or its supporting business system. The correction of these errors must be performed by returning to a development phase. The development phase operates concurrently with service operations as shown.

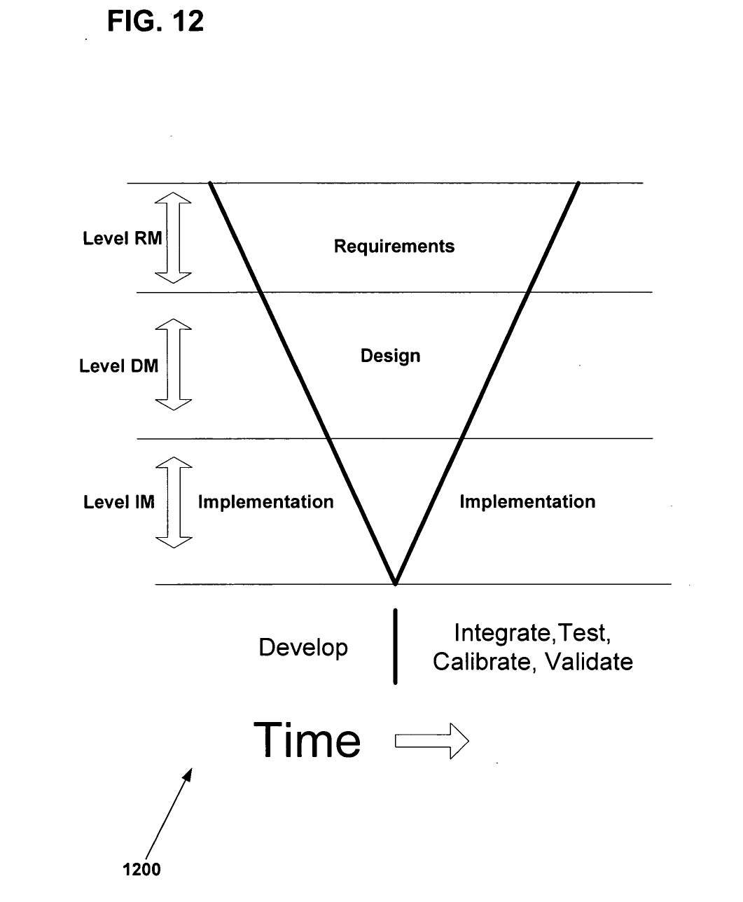

FIG. 12 is a process diagram illustrating the vehicle development phase containing prototype cycles 1200 as conceptual “V” cycles, according to an exemplary embodiment of the present disclosure.

The Development Phase 902, FIG. 9, includes prototype cycles 1200 that follow the shape of a “V”. The “V” begins with the development of some parts of a vehicle model and business system as requirements, then optionally proceeds to development of parts of the design model and then optionally to development of parts of the implementation model. At the bottom of the “V”, the focus of development activity then shifts to integration, testing, calibration, and validation of the parts of the model that have been developed.

The “down cycle” is on the left and the “up cycle” is on the right side of the diagram. Horizontally across the “V” is a corresponding part of the model to be integrated, tested, calibrated, or validated. After being partially developed, components of requirements can be integrated, tested, and validated through methods like simulation. An early prototype “V” cycle might only include development and testing of requirements. After some parts of the design or implementation model have been developed, that part of the model can be integrated, tested, and validated with the previous parts of the model for the vehicle and business system. Each prototype cycle develops, integrates, tests, and validates more parts of the model, with components that include requirements, design, and implementation.

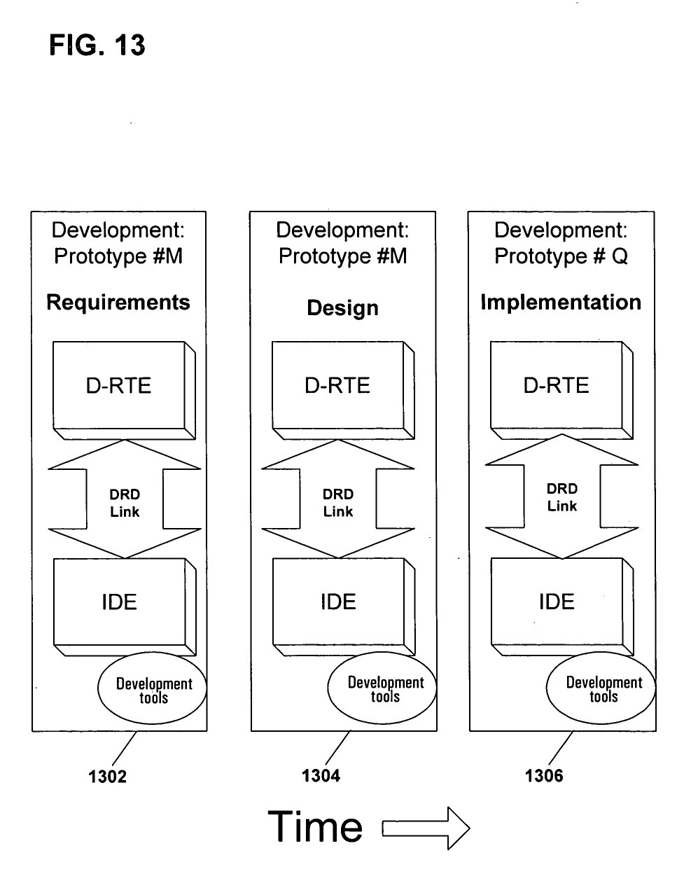

FIG. 13 is a process diagram illustrating how the lifecycle method progresses using the spiral process through requirements, design, and implementation, according to an exemplary embodiment of the present disclosure.

The development phase 902, FIG. 9, progresses through prototyping cycles 1302, 1304, 1306. Each cycle initially moves through a “down cycle” of the “V” cycle that includes the development of the model in terms of the attributes of requirements, then design, and finally implementation. Early “down cycles” need only develop requirements before entering an “up cycle” to begin testing and validating the requirements. Most prototyping cycles in the development phase will include the development of the model in terms of the attributes of requirements, design, and implementation in the “down cycle”.

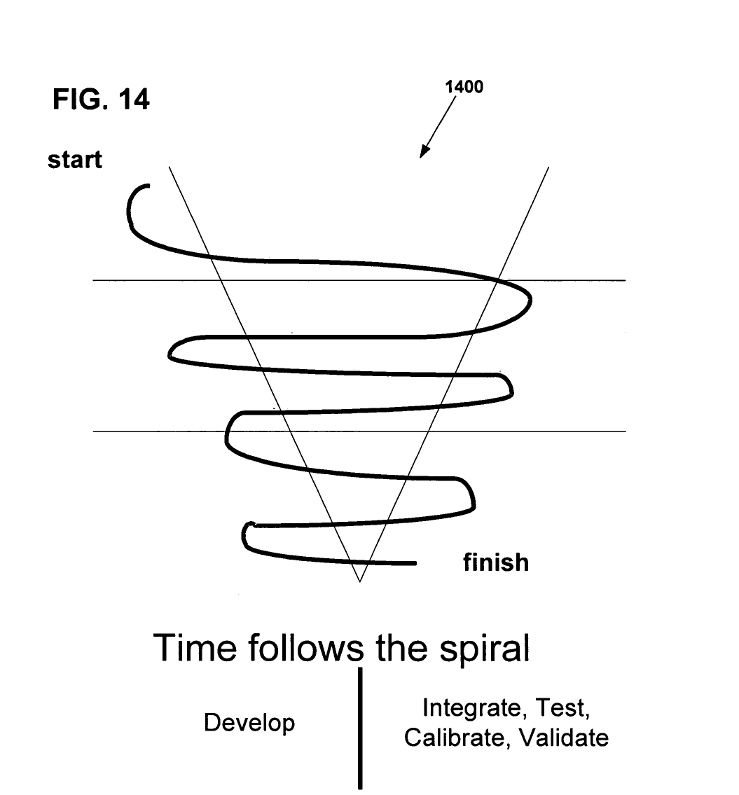

FIG. 14 is a process diagram illustrating how the lifecycle method applies a spiral sub process, according to an exemplary embodiment of the present disclosure.

The development phase 902, FIG. 9, includes prototype cycles 1400. The cycles 1400 use a spiral process to move through the “V” initially in a “down cycle” as illustrated. With the spiral process, parts of the requirements attributes of the prototype model are developed and then tested, followed by parts of the design being developed and then tested, and then parts of the implementation attributes are developed and then tested.

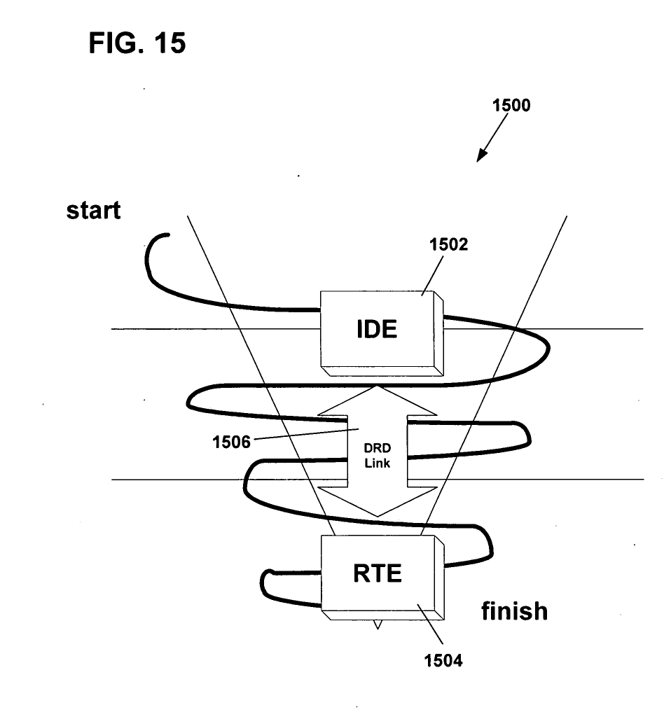

FIG. 15 is a process diagram illustrating how the lifecycle method is applied with a linked IDE and RTE, according to an exemplary embodiment of the present disclosure.

The development phase 902, FIG. 9, has prototype cycles 1500 and uses a spiral process to move through the “V”. In developing parts of the model, an IDE 1502 is required. In testing, calibrating, and validating parts of the implementation model, a RTE 1504 is required. To effectively move along the spiral process, the IDE 1502 and RTE 1504 should be linked via a DRD link 1506. The IDE 1502 is mainly applied on the top and middle of the “V”, and the RTE 1304 is applied on the bottom of the “V”. The spiral process that moves through the “V” is enabled by the linked IDE 1502 and RTE 1504. The linkage is required during “down cycles” and “up cycles”. In the “down cycle” the information flow is mainly from the IDE 1502 to the RTE 1504 because the focus is on ending with an implementation as a RTE 1504.

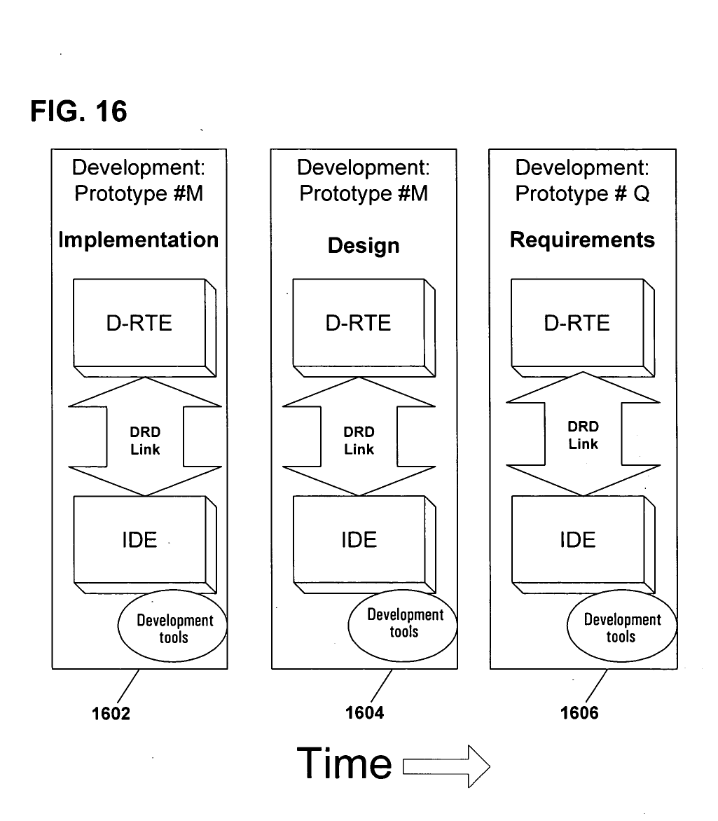

FIG. 16 is a process diagram illustrating how the lifecycle method progresses, according to an exemplary embodiment of the present disclosure.

The development phase 902, FIG. 9, progresses through prototyping cycles 1602, 1604, 1606. Each cycle eventually moves through an “up cycle” in the “V” that includes the integration, testing, calibration, and validation of the model in terms of the attributes of implementation, then design, and finally requirements. Early “up cycles” involve only requirements. Later “up cycles' involve requirements and design. Most prototyping cycles in the development phase will include the development of the model in terms of the attributes of requirements, design, and implementation in the “down cycle” followed by the integration, testing, calibration, and validation of the implementation, design, and requirements in an “up cycle”.

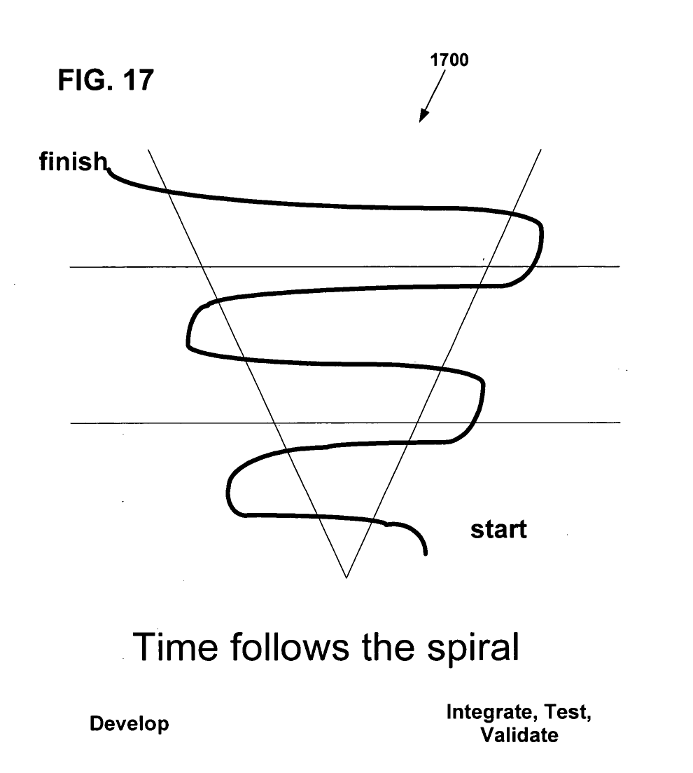

FIG. 17 is a process diagram illustrating how the lifecycle method applies a spiral sub process, according to an exemplary embodiment of the present disclosure.

The development phase 902, FIG. 9, includes prototype cycles. The cycles use a spiral process 1700 to move through the “V” initially in a “down cycle” and then in an “up cycle” as illustrated. With the spiral process, parts of the implementation attributes of the prototype model are integrated and then tested, followed by parts of the design being developed and then tested, and then parts of the requirements attributes are then tested and validated.

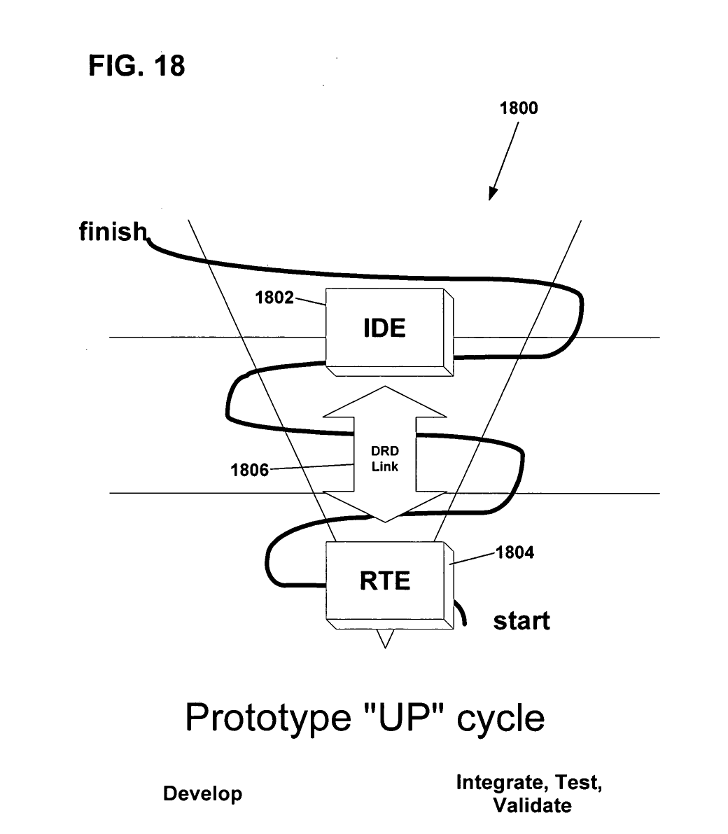

FIG. 18 is a process diagram illustrating how the lifecycle method is applied in the spiral sub process, according to an exemplary embodiment of the present disclosure.

The development phase 902, FIG. 9, has prototype cycles and uses a spiral process 1800 to move through the “V”. In developing parts of the model, an IDE 1802 is required. In testing, calibrating, and validating parts of the implementation model, a RTE 1804 is required. To effectively move along the spiral process, the IDE 1802 and RTE 1804 should be linked via a DRD link 1806. The IDE 1802 is mainly applied on the top and middle of the “V”, and the RTE 1804 is applied on the bottom of the “V”. The spiral process 1800 that moves through the “V” is enabled by the linked the IDE 1802 and the RTE 1804. The linkage is required during “down cycles” and “up cycles”. In the “up cycle”, the information flow is mainly from the RTE 1804 to the IDE 1802 because the focus is on ending with a validated model with a set of requirements and a design in the IDE.

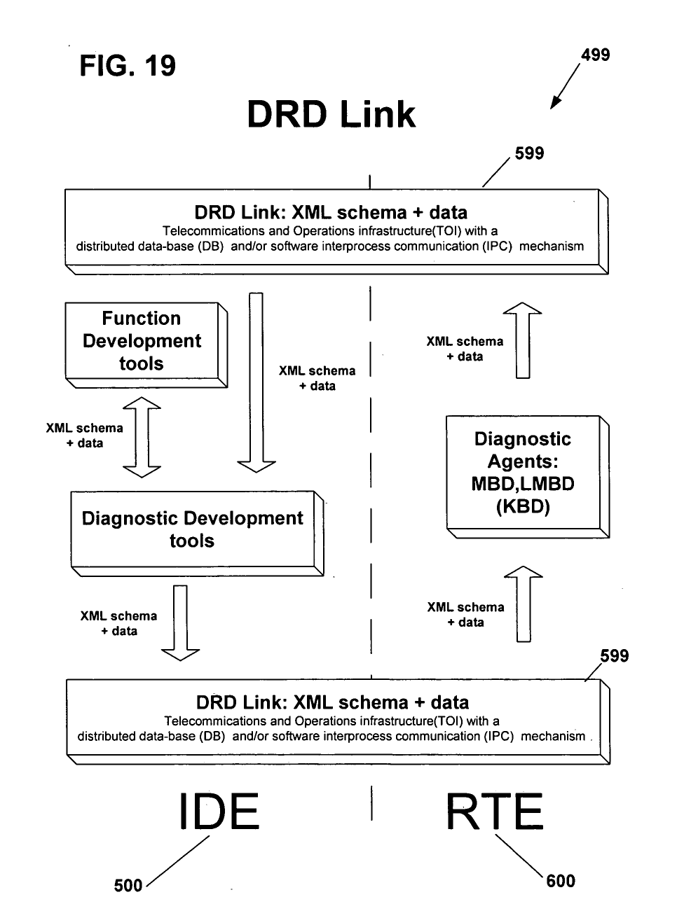

As shown in FIG. 19, a diagnostic agent, built with a specific DID-I that it reads as internal data, can detect a failure in a corresponding function's module in the RTE 600. The agent then accesses the DRD 599 to find the FID-I linkage to write information into the DRD 599 that can be read by any of the tools in the IDE 500 or by additional agents in the RTE 600. If the agent is in an ECU and the ECU has no direct access to the DRD 599, the agent sends a message to an agent in the TCU, which does have access to the DRD 599.

Once linked to the IDE 500, round-trip engineering of the diagnostics to functions is enabled using the linkages inside the IDE 500 guided by the information created in the DRD 599 by the RTE 600.

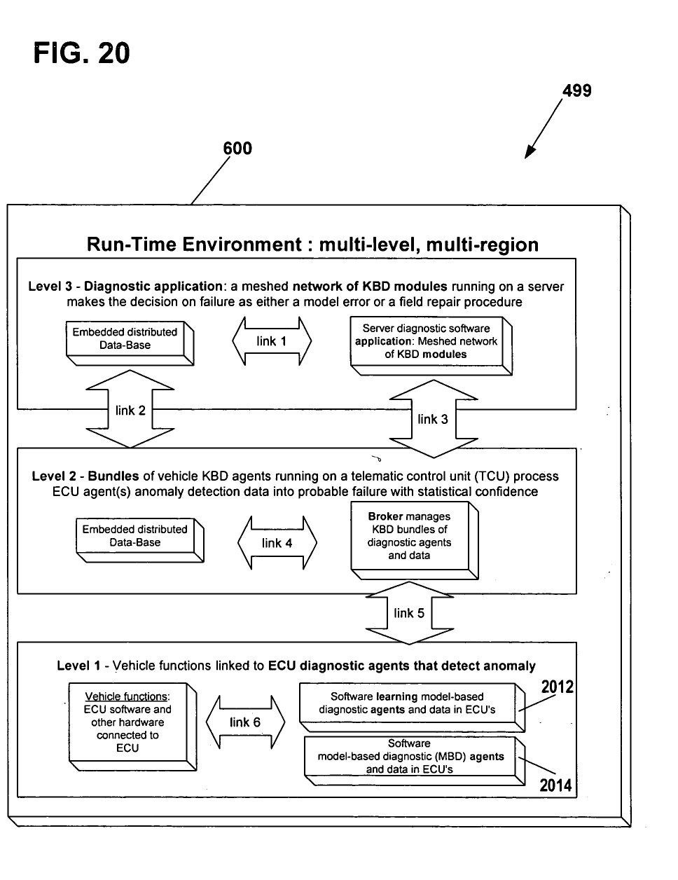

As shown in FIG. 20, the system 499 uses first and second agents 2012, 2014 to detect failures. The second agent 2014 is a model-based diagnostic (MBD) agent that can use a model and iterative procedures to determine a root cause for known failure modes. Examples of such agents are the MBD agents built using a tool such as R.O.S.E. Rodon™. These MBD agents are not effective with new failures that were not anticipated in the model. To compensate for that gap in detection capability, the system 499 creates and applies the first agent 2012, or a learning model-based diagnostic (LMBD) agent, using embedded data mining algorithms, such as time-frequency analysis (TFA), that learn a model by observing an operating vehicle. These algorithms are trained and calibrated during specific normal operating times and then placed in a watch mode at run-time in the vehicle RTE 600.

In the system 499, the LMBD agents 2012 detect a superset of the failures detected by the MBD agents 2014. The LMBD failures can be classified as either (1) a previously anticipated failure that can be fixed in the field, or (2) a new failure that can be either a model error or another new type of hardware failure. The classification occurs by comparing the output of the MBD agents 2014 with the LMBD agents 2012. If the MBD agents 2014 have seen the failure mode before with a statistical confidence factor, then the failure is probably not a model error. If the MBD agents 2014 have a low confidence factor indicating a new failure mode not previously seen, then a model error needs to be investigated and the service technician is told not to swap a part in the field.

An investigation occurs as the RTE agents write information into the DRD link 599, FIG. 6, which enables the IDE 500, FIG. 5, to trace the failures back to the levels of the model represented at the levels of implementation, design and requirements.

The system 499 identifies which functions are linked to the failure. A simulation can be run in the IDE 500, FIG. 5, to duplicate the failure mode. The simulation assists in the determination of the root cause.

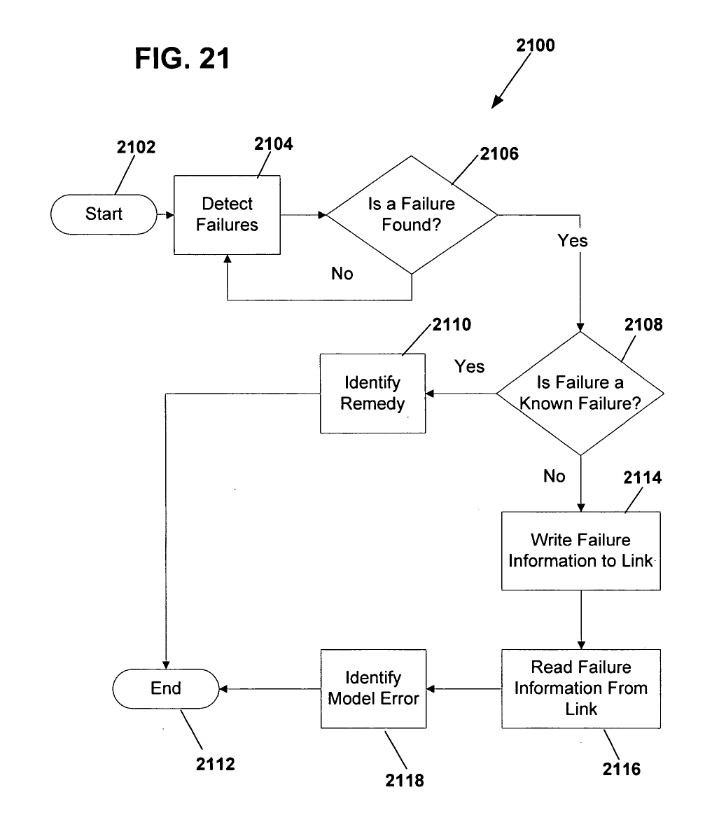

FIG. 21 is a flow chart representing logical operations of a learning model-based diagnostic system 2100. Entrance to the operational flow of the learning model-based diagnostic system 2100 begins at a flow connection 2102. A detect operation 2104 detects a failure. It is noted that diagnostic agents, such as those previously described herein, continuously monitor a vehicle's functions. Such agents are generally located within the RTE, such as RTE 600 of FIG. 6, operating on a vehicle. A found module 2106 determines if a failure has been found. If the found module 2106 determines that a failure has not been found, operational flow branches “No” to the detect operation 2104. In this manner, the vehicle is continuously monitored.

If the found module 2106 determines that a failure has been found, operational flow branches “Yes” to a known module 2108. The known module 2108 determines if the failure is a known failure. If the known module 2108 determines that the failure is a known failure, operational flow branches “Yes” to an identify operation 2110. The identify operation 2110 identifies the remedy for the known failure. Operational flow ends at termination point 2112.

If the known module 2108 determines that the failure is not a known failure, operational flow branches “No” to a write operation 2114. The write operation 2114 writes the failure information to a link, such as the DRD link 599 of FIG. 6. A read operation 2116 reads the failure information from the link. The failure is read into the IDE, such as IDE 500 of FIG. 5. A model operation 2118 identifies the model error, which may be an error is the requirements, design, or implementation level of the IDE. Operational flow ends at termination point 2112.

One skilled in the art would recognize that the system described herein can be implemented using any number of software configurations, network configurations, and the like.

The logical operations of the various embodiments illustrated herein are implemented (1) as a sequence of computer implemented steps or program modules running on a computing system and/or (2) as interconnected logic circuits or circuit modules within the computing system. The implementation is a matter of choice dependent on the performance requirements of the computing system implementing the invention. Accordingly, the logical operations making up the embodiments of the present invention described herein are referred to variously as operations, steps, engines, or modules.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A system for learning model-based lifecycle diagnostics, the system comprising:
an integrated development environment having software tools linked within;
a run-time environment having agents that detect failures linked within; and
a bi-directional link between the integrated development environment and the run-time environment;
whereby the failures detected in the run-time environment are traced back to the integrated development environment to determine model errors.

2. A system according to claim 1, wherein the integrated development environment includes requirements management tools, design tools, and implementation tools linked together.

3. A system according to claim 2, wherein the requirements management tools includes an object oriented requirements management tool and an issue-based information system requirements management tool.

4. A system according to claim 2, wherein the design tools include an object oriented model driven function design tool, a knowledge-based diagnostics design tool, and a model-based diagnostic design tool.

5. A system according to claim 2, wherein the implementation tools include a software function code generation, management, and deployment tool, and a software diagnostic code generation, management.

6. A system according to claim 1, wherein the run-time environment includes diagnostic agents.

7. A system according to claim 6, wherein the diagnostic agents include model-based diagnostic agents and learning model-based diagnostic agents.

8. A system according to claim 1, wherein the run-time environment includes a database, a server software tool, a broker, and diagnostic agents.

9. A system according to claim 1, wherein the bi-directional link is a DRD link.

10. A system according to claim 9, wherein the DRD link includes a database.

11. A system according to claim 10, wherein the database is a distributed database.

12. A system for learning model-based lifecycle diagnostics for vehicles, the system comprising:
an integrated development environment including a requirements management tool, a design tool, and a deployment tool linked together;
a run-time environment having applications, brokers, and agents that detect failures linked together; and
a bi-directional link between the integrated development environment and the run-time environment;
whereby the failures detected in the run-time environment are traced back to the integrated development environment to determine model errors.

13. A system according to claim 12, wherein the requirements management tool includes an object oriented requirements management tool and an issue-based information system requirements management tool.

14. A system according to claim 12, wherein the design tool includes an object oriented model driven function design tool, a knowledge-based diagnostics design tool, and a model-based diagnostic design tool.

15. A system according to claim 12, wherein the implementation tool include a software function code generation, management, and deployment tool, and a software diagnostic code generation, management.

16. A system according to claim 12, wherein the agents are diagnostic agents.

17. A system according to claim 16, wherein the diagnostic agents include model-based diagnostic agents and learning model-based diagnostic agents.

18. A system according to claim 12, wherein the bi-directional link is a DRD link.

19. A system according to claim 18, wherein the DRD link includes a database.

20. A system according to claim 19, wherein the database is a distributed database.

21. A method of diagnosing model errors in a software environment including an integrated development environment and a run-time environment bi-directionally linked by a link, the method comprising:
detecting failures within the run-time environment;
tracing the failures back to the integrated development environment; and
identifying the model errors in the integrated development environment based on the tracing of the failures.

22. A method according to claim 21, wherein detecting failures includes using model-based diagnostic agents to detect failures within the run-time environment.

23. A method according to claim 22, further comprising determining root causes for known failure modes based on the failures detected by the model-based diagnostic agents.

24. A method according to claim 21, wherein detecting failures includes using learning model-based diagnostic agents to detect failures within the run-time environment.

25. A method according to claim 24, wherein detecting failures includes the diagnostic agents using embedded data mining algorithms that learn a model by observing.

26. A method according to claim 24, wherein tracing failures includes the diagnostic agents writing information into the link.

27. A method according to claim 26, wherein tracing failures includes reading the information in the link into the integrated development environment.

28. A method according to claim 27, wherein identifying the model errors includes identifying the model errors in the levels of the model represented at the levels of implementation, design, and requirements.

29. A computer program product readable by a computing system and encoding instructions diagnosing model errors in a software environment including an integrated development environment and a run-time environment bi-directionally linked, the computer process comprising:
detecting failures within the run-time environment;
tracing the failures back to the integrated development environment; and
identifying the model errors in the integrated development environment based on the tracing of the failures.

30. A computer program product according to claim 29, wherein detecting failures includes using model-based diagnostic agents to detect failures within the run-time environment.

31. A computer program product according to claim 30, further comprising determining root causes for known failure modes based on the failures detected by the model-based diagnostic agents.

32. A computer program product according to claim 29, wherein detecting failures includes using learning model-based diagnostic agents to detect failures within the run-time environment.

33. A computer program product according to claim 32, wherein detecting failures includes the diagnostic agents using embedded data mining algorithms that learn a model by observing.

34. A computer program product according to claim 32, wherein tracing failures includes the diagnostic agents writing information into the link.

35. A computer program product according to claim 34, wherein tracing failures includes reading the information in the link into the integrated development environment.

36. A computer program product according to claim 35, wherein identifying the model errors includes identifying the model errors in the levels of the model represented at the levels of implementation, design, and requirements.
